(19) United States
(12) Patent Application Publication
(10) Pub. No.: US 2021/0001488 A1
(43) Pub. Date: Jan. 7, 2021

(54) SILVERWARE PROCESSING SYSTEMS AND METHODS

(71) Applicant: Dishcraft Robotics, Inc., San Carlos, CA (US)

(72) Inventors: Paul Michael Birkmeyer, San Carlos, CA (US); Kerkil Choi, Los Gatos, CA (US); Kenneth McAfee Peters, San Mateo, CA (US); Parth Shah, Palo Alto, CA (US); Linda Pouliot, San Mateo, CA (US)

(21) Appl. No.: 16/502,528

(22) Filed: Jul. 3, 2019

(51) Int. Cl. B25J 9/16; B25J 15/06; B25J 11/00

(52) U.S. Cl. CPC B25J 9/1697; B25J 9/1679; A47G 21/023; B25J 11/0045; B25J 15/0608

(57) ABSTRACT

An imaging system captures images of a work surface having articles of cutlery distributed thereon. An end effector, such as a magnetic end effector, may be used to grasp articles of cutlery and place them in a designated location according to the type of the article of cutlery as determined using an image of the work surface and machine vision. A type of articles of cutlery may be classified based on the image such as according to category (knife, fork, spoon), size, or brand. Multiple articles of cutlery occluding one another may be dealt with by stirring or grasping multiple items and releasing them on a separate work surface in order to disperse them. Whether the end effector is grasping multiple articles of cutlery may be determined by capturing an image of the end effector. Machine vision may determine whether an article of cutlery is contaminated or damaged.

### TECHNICAL FIELD

The present disclosure relates to systems and methods that use imaging systems and associated image analysis techniques to detect, identify, and manipulate an article of silverware.

### BACKGROUND

One costly aspect of operating a restaurant is dealing with used dishware and flatware. The process of collecting and cleaning dishware and flatware is a time intensive manual process but has the advantage of eliminating the use of single-use plastics.

It would be an advancement in the art to provide an improved approach for cleaning dishware and flatware.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a schematic diagram depicting an embodiment of a silverware identification system.

FIG. 2 is a block diagram depicting an embodiment of a processing system capable of operating a silverware identification system configured to identify an article of silverware.

FIG. 3 is a block diagram depicting an embodiment of an image analysis system.

FIG. 4 is a block diagram depicting an embodiment of a robotic actuator interface.

FIG. 5 is a schematic diagram depicting an embodiment of a silverware identification system that is configured to sort articles of silverware.

FIG. 6 is a schematic diagram depicting an embodiment of a silverware identification system that is configured to reorient articles of silverware.

FIG. 7 is a schematic diagram depicting an embodiment of a magnetic end effector.

FIG. 8 is a schematic diagram depicting an example of damaged or dirty articles of cutlery.

FIG. 9 is a flow diagram depicting an embodiment of a method to identify an article of cutlery.

FIG. 10 is a flow diagram depicting an embodiment of a method to detect a presence of dirt or damage on an article of cutlery.

FIG. 11 is a flow diagram depicting an embodiment of another method to detect a presence of dirt or damage on an article of cutlery.

FIGS. 12A and 12B are flow diagrams depicting an embodiment of a method to grip a single article of cutlery from a collection using a magnetic gripper.

FIG. 13 is a flow diagram depicting an embodiment of a method to identify a type of an article of cutlery.

FIG. 14A is a block diagram illustrating function of an object detector.

FIG. 14B is a block diagram illustrating an alternative function of an object detector.

FIG. 15 is a block diagram illustrating an approach for determining an oriented bounding box and polarity of an article of cutlery.

FIG. 16A is a block diagram illustrating an alternative approach for determining an oriented bounding box and polarity of an article of cutlery.

FIG. 16B is a block diagram illustrating another alternative approach for determining an oriented bounding box and polarity of an article of cutlery.

FIG. 17 is a block diagram illustrating classification of an article of cutlery.

FIG. 18 is a block diagram illustrating an approach for identifying anomalies on an article of cutlery.

FIG. 19 is a block diagram illustrating an alternative approach for identifying anomalies on an article of cutlery.

FIG. 20 is a diagram illustrating visualization of an anomaly.

FIG. 21 is a block diagram illustrating detection of multiple articles of cutlery engaged with an end effector.

FIG. 22 is a diagram illustrating processing of multiple articles of cutlery engaged with an end effector.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

The systems and methods described herein use a robotic apparatus and one or more imaging systems and associated image analysis techniques to detect and identify an article of silverware (also referred to herein as an “article of cutlery”). In some embodiments, a robotic actuator is used to engage an article of cutlery from a collection of articles of cutlery. The robotic actuator then presents the article of cutlery in a field of view of an imaging system that is configured to capture an image of the article of cutlery. A processing system is configured to process the image and identify a type of the article of cutlery, as described herein.

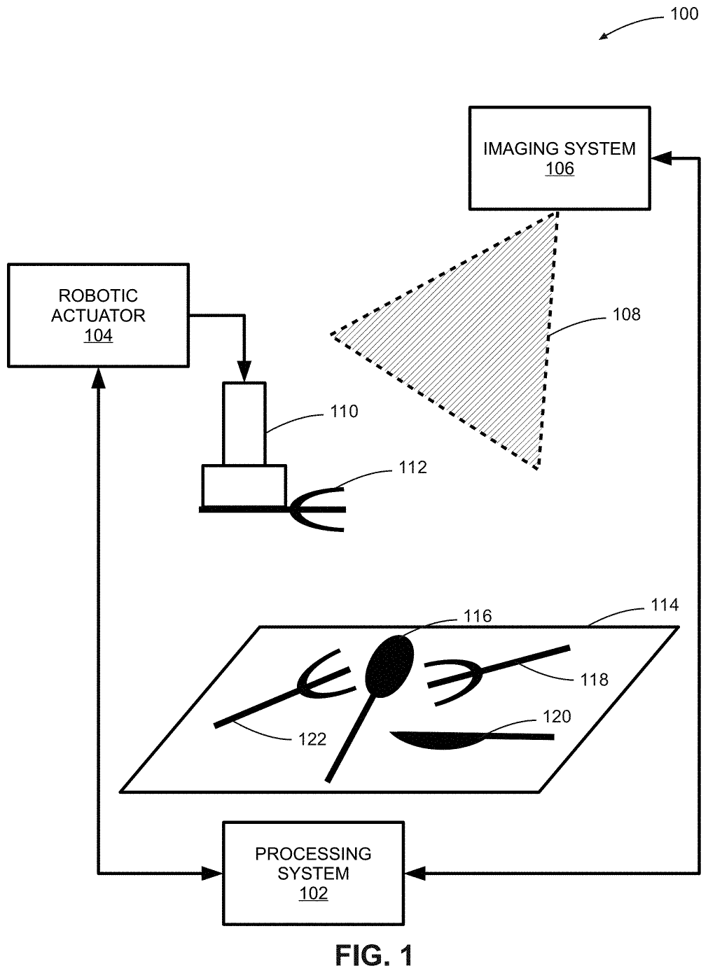

FIG. 1 is a schematic diagram depicting an embodiment of a silverware identification system 100. In some embodiments, silverware identification system 100 includes a robotic actuator 104 that includes (i.e., is mechanically coupled to) a magnetic end effector 110. Although the following description references a magnetic end effector, other end effectors may be used such as a gripper including fingers that rotated or translate relative to one another for pinching and grasping objects. Accordingly, grasping and releasing with the magnetic end effector 110 as described herein shall be understood to be substitutable with grasping and releasing by means of pinching and separating fingers of a gripper. For example, a gripper may be embodied as any of the embodiments of the gripper described in U.S. application Ser. No. 16/363,708 filed Mar. 25, 2019 and entitled Automated Manipulation of Transparent Vessels (Attorney Docket No. DISH-01500), which is hereby incorporated herein by reference in its entirety.

Robotic actuator 104 is configured to receive commands from a processing system 102 to engage an article of cutlery 112 using magnetic end effector 110. Magnetic end effector may also be referred to as a “magnetic gripper.” In some embodiments engaging article of cutlery 112 by robotic actuator 104 is accomplished by processing system 102 issuing a command to robotic actuator 104 to move magnetic end effector 110 proximate a plurality (i.e., a collection) of articles of cutlery that includes an article of cutlery 116, an article of cutlery 118, an article of cutlery 120, and an article of cutlery 122, disposed on a work surface 114. In some embodiments, the plurality of articles of cutlery may be in a container such as a work bin or a cutlery bin.

In some embodiments, article of cutlery 112 is randomly engaged by magnetic end effector 110 from the collection of articles of cutlery (i.e., article of cutlery 116 through article of cutlery 112). In other words, magnetic end effector 110 engages a random (i.e., unidentified) article of cutlery from the collection. Robotic actuator 104 is then commanded by processing system 102 to present article of cutlery 112 in a field of view 108 of an imaging system 106. Robotic actuator 104 may be commanded by processing system 102 to present article of cutlery 112 in field of view 108 in a specific spatial orientation. In some embodiments, imaging system 106 may include any combination of imaging devices such as ultraviolet (UV) cameras, infrared (IR) cameras, visible light RGB (red green blue) cameras, hyperspectral imaging cameras, high dynamic range (HDR) cameras, and so on. Different lighting systems such as tungsten lighting, fluorescent lighting, UV lighting, IR lighting, or other lighting systems may also be included in imaging system to appropriately illuminate article of cutlery 112.

In some embodiments, imaging system 106 is configured to capture an image of article of cutlery 112. In particular embodiments, a command to capture the image may be issued to imaging system 106 via processing system 102. Processing system 102 then receives the image and performs image processing on the image by, for example, running computer vision algorithms, to identify a type of article of cutlery 112. Details about these computer vision algorithms are provided herein. In FIG. 1, article of cutlery 112 is shown to be a fork, while article of cutlery 116 is a spoon, article of cutlery 118 is a fork, article of cutlery 120 is a knife, and article of cutlery 122 is a fork. Some embodiments of silverware identification system 100 may be configured to operate on a collection of articles of cutlery with hundreds, or even thousands, of articles of cutlery. In some embodiments, a random article of cutlery in a collection is engaged by robotic actuator 104, imaged by imaging system 106, and identified by processor 102. In other embodiments, an article of cutlery in a collection is first imaged by imaging system 106, identified by processing system 102, and then engaged by robotic actuator 104.

In some embodiments, once a type of article of cutlery 112 has been identified, processing system 102 is configured to sort the article of cutlery. For example, in FIG. 1, article of cutlery 112 is shown to be a fork. In this case, processing system 102 may be configured to place article of cutlery 112 in a set of articles of cutlery that contain only forks. In other embodiments, processing system 102 may be configured to place article of cutlery in a designated place based on a type of the article of cutlery (e.g., spoon, knife or fork).

In some embodiments, a process of engaging an article of cutlery from a collection of a plurality of articles of cutlery includes processing system 102 issuing a command to robotic actuator 104 to move magnetic end effector 110 towards the collection. When magnetic end effector 110 is in a proximity to the collection, magnetic attraction from magnetic end effector 110 causes an article of cutlery to attach itself to magnetic end effector 110. In some embodiments, magnetic end effector 110 includes a permanent magnet that engages an article of cutlery from the collection via magnetic attraction when magnetic end effector 110 is close enough to the collection. In other embodiments, magnetic end effector includes an electromagnet that is normally deactivated, but is activated when magnetic end effector 110 is close enough to the collection such that an article of cutlery is attracted to and engaged by the electromagnet. Commands for activating and deactivating an electromagnet associated with magnetic end effector 110 may be issued by processing system 102.

In some embodiments, processing system 102 may issue spatial orientation commands to robotic actuator 104 that places article of cutlery 112 in field of view 108 of imaging system 106 in a specific orientation. In particular embodiments, spatial orientation commands may include placing article of cutlery 112 in field of view 108 in front of a predetermined background. In other embodiments, imaging conditions such as lighting and background associated with imaging system 106 capturing an image of article of cutlery 112 may be controllable. For example, once an article of cutlery is engaged by magnetic end effector 110 and placed in field of view 108, assuming that a pose of robotic actuator 104 relative to imaging system 106 is known and can be tracked by processing system 102, it is possible for processing system 102 to identify and predetermine desired poses of robotic actuator 104 for imaging that could potentially yield better contrast and signal to noise ratio as well as a better viewing angle.

As discussed herein, holding a single article of cutlery at a time in field of view 108 greatly improves an identification success probability of a computer vision system running on processing system 102, where the computer vision system is configured to identify a type of the article of cutlery. The computer vision system in this case can also then be used to identify objectionable issues with this article of cutlery. Some such objectionable issues are broken or bent cutlery, bent tines on forks, missing tines on forks or any other damage, or dirt remaining on the silverware, as discussed herein. These items could then be segregated from the items that are going to be put back into service in, for example, a restaurant.

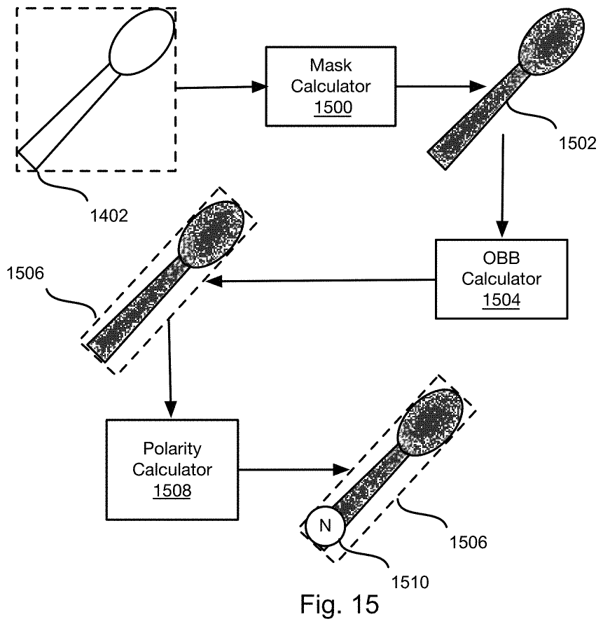

Other enhancements to a computer vision system used by processing system 102 to detect and identify an article of cutlery include an ability to perform more subtle sorting that goes beyond sorting an article of cutlery based on its type (e.g., spoon, fork, or knife). In some embodiments, the type of an article of cutlery may be identified based on its category (spoon, fork, knife) and other attributes such as orientation (see discussion of FIGS. 15-17), size, brand, and/or pattern on its handle. For example, if a user of the system wants to segregate forks from different brands that show different symbols or marks or text in the handle, the vision-based sorting algorithm could be configured to perform this task.

In some embodiments, silverware identification system 100 may be configured to generate multiple views of article of cutlery 112 by capturing multiple images of article of cutlery 112 using imaging system 106. For generating multiple views, multiple cameras may be included in imaging system 106, where each camera is configured to image article of cutlery 112 from a different perspective or angle of view. Using multiple cameras allows for relatively high-speed image acquisition for pose estimation. In other embodiments, additional flexibility may be added to silverware identification system 100 by configuring robotic actuator 104 such that robotic actuator 104 can modify poses in which article of cutlery 112 is presented to an imaging system 106.

In some embodiments, using a robotic actuator 104 to change a pose of an article of cutlery in front of imaging system 106 allows naturally for multiple views. This process essentially uses a plurality of spatial orientations associated with the article of cutlery when the article of cutlery is presented in field of view 108. Oftentimes, a single view, no matter how good the image is, is not sufficient for classification with a high confidence level. An alternative solution is to use multiple views associated with an article of cutlery. Once robotic actuator 104 engages an article of cutlery, it can present the article of cutlery with many different poses and scales in field of view 108 associated with imaging system 106. Variations in exposure time may be used to improve signal to noise ratios (SNRs) and contrast based on intermediate classification results. In this case, rather than taking a set of pictures and trying to combine them after collecting them, imaging system 106 acquires one image at a time, and processing system 102 outputs classification results based on what has been collected up to that time point to give feedback to processing system 102 via imaging system 106 to design a next imaging location, until silverware identification system 100 is highly confident about classification results produced by processing system 102.

In some embodiments, a process of placing an article of cutlery at a designated location includes processing system 102 commanding robotic actuator 104 to move article of cutlery 112 engaged (grasped) by magnetic end effector 110 to the designated location, and placing article of cutlery 112 at the designated location. In order to place article of cutlery 112 at the designated location, article of cutlery must be disengaged from magnetic end effector 110. If the magnet associated with magnetic end effector 110 is a permanent magnet, this disengagement may be done via mechanical methods such as having a mechanical fixture that holds article of cutlery 112 in place while robotic actuator pulls magnetic end effector 110 in an opposite direction to disengage magnetic end effector 110 from article of cutlery 112. If the magnet associated with magnetic end effector 110 is an electromagnet, disengagement may be done by deactivating the electromagnet to release article of cutlery 112. These disengagement methods may be used by silverware identification system 100 for not only placing article of cutlery in a designated location, but also sorting article of cutlery 112, as discussed herein.

In some embodiments, a collection of articles of cutlery includes spoons, forks, and knives, and silverware identification system 100 is configured to identify and place all the forks and all the knives from the collection at separated designated locations. When all the forks and knives in the collection have been identified and removed from the collection in this way, the remaining articles of cutlery in the collection are spoons. This constitutes an efficient sorting algorithm where computer vision algorithms associated with silverware identification system 100 need to detect and identify two types of articles of cutlery instead of three.

Some embodiments of silverware identification system 100 engage an article of cutlery before presenting the article of cutlery to imaging system 106. Other embodiments of silverware identification system 100 use imaging system 106 to identify a specific article of cutlery in a collection of articles of cutlery before engaging the article of cutlery. In restaurant applications, silverware identification system 100 can be used to sort a collection of dirty articles of cutlery before they are sent through a sanitizer in the restaurant. Or, if sorting is done after the articles of cutlery are run through the sanitizer, a sorting algorithm associated with silverware identification system could pick out forks and knives, leaving only the spoons, or any single item of cutlery. This method reduces the sorting time considerably, because a user does not have to spend time moving the items in the last batch of articles of cutlery, these items arrive at a sorted state by way of removing all of the other unlike items.

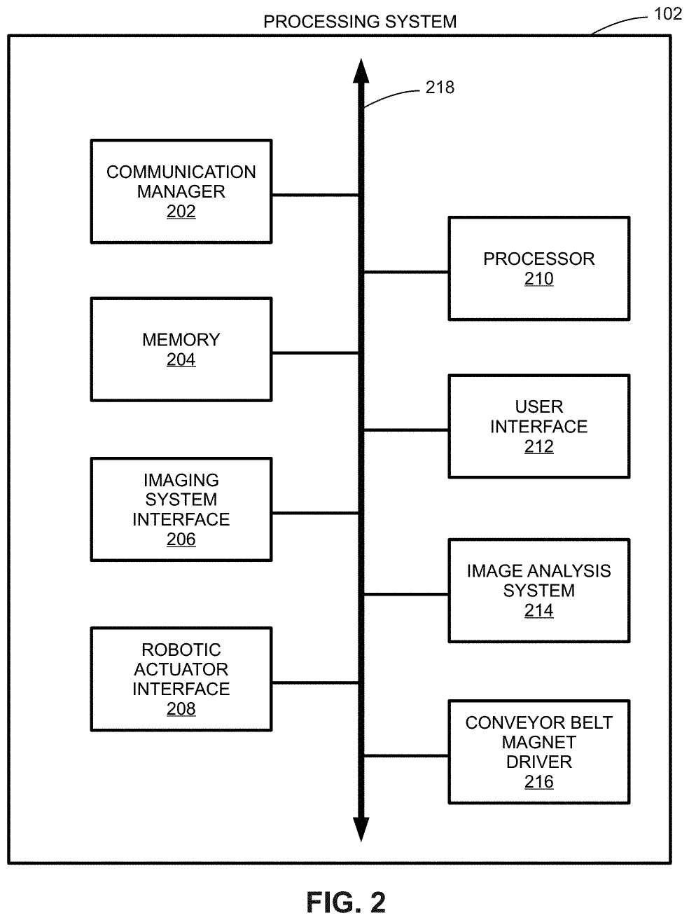

FIG. 2 is a block diagram depicting an embodiment of a processing system 102 capable of operating silverware identification system 100 that is configured to identify an article of silverware. In some embodiments, processing system 102 includes a communication manager 202 that is configured to manage communication protocols and associated communication with external peripheral devices, as well as communication within other components in processing system 102. For example, communication manager 202 may be responsible for generating and maintaining an interface between processing system 102 and imaging system 106, and generating and maintaining an interface between processing system 102 and robotic actuator 104.

In some embodiments, processing system 102 includes a memory 204 that is configured to store data associated with silverware identification system 100. Data stored in memory 204 may be temporary data or permanent data. In some embodiments, memory 204 may be implemented using any combination of hard drives, random access memory, read-only memory, flash memory, and so on. In particular embodiments, data stored in memory 204 may include data from imaging system 106.

Some embodiments of processing system 102 may also include an imaging system interface 206 that is configured to interface processing system 102 with one or more imaging systems such as imaging system 106. In some embodiments, imaging system interface 206 may include any combination of connectivity protocols such as IEEE 1394 (FireWire), Universal Serial Bus (USB), and so on. Imaging system interface 206 allows processing system 102 to receive images from an associated imaging system, while also sending commands to the imaging system (e.g., a command to capture an image of article of cutlery 112 when article of cutlery 112 is in a field of view of imaging system 106).

In some embodiments, processing system 102 may include a robotic actuator interface 208 that is configured to interface processing system 102 with robotic actuator 104. Commands issued by processing system to robotic actuator 104 are transmitted to robotic actuator 104 via robotic actuator interface 208. Examples of such commands include a command to move robotic actuator 104 to a specific point in space, a command to activate an electromagnet associated with magnetic end effector 110, and so on. Other examples of general commands include positioning commands, object gripping commands, object release commands, object repositioning commands, and so on. In some embodiments, robotic actuator interface 208 may be configured to receive feedback data from robotic actuator 104. For example, data from a Hall effect sensor that is included in magnetic end effector 110 may generate electrical signals that indicate that magnetic end effector 110 has engaged or gripped multiple articles of cutlery, as described herein.

Processing system 102 may also include a processor 210 that may be configured to perform functions that may include generalized processing functions, arithmetic functions, and so on. Processor 210 may also be configured to perform three-dimensional geometric calculations and solve navigation equations in order to determine relative positions, trajectories, and other motion-related and position-related parameters associated with manipulating an article of cutlery by robotic actuator 104.

A user interface 212 may be included in processing system 102. In some embodiments, user interface 212 is configured to receive commands from a user or display information to the user. For example, commands received from a user may be basic on/off commands, and may include variable operational speeds. Information displayed to a user by user interface 212 may include, for example, system health information and diagnostics. User interface 212 may include interfaces to one or more switches or push buttons, and may also include interfaces to touch-sensitive display screens.

In some embodiments, processing system 102 includes an image analysis system 214 that is configured to process images of an article of cutlery captured by, for example, imaging system 106 to identify the article of cutlery. Image analysis system 214 may include subsystems that implement computer vision algorithms for processing the images, as described herein.

In some embodiments, processing system 102 includes a conveyor belt magnet driver 216 that is configured to rotate a magnet under a conveyor belt that carries articles of cutlery. By rotating the magnet, conveyor belt magnet driver 216 individually orients each article of cutlery on the conveyor belt so that the article of cutlery is in a specific spatial orientation relative to an imaging system that is configured to capture an image of the article of cutlery. Details about this embodiment are provided herein.

A data bus 218 interconnects all subsystems associated with processing system 102, transferring data and commands within processing system 102.

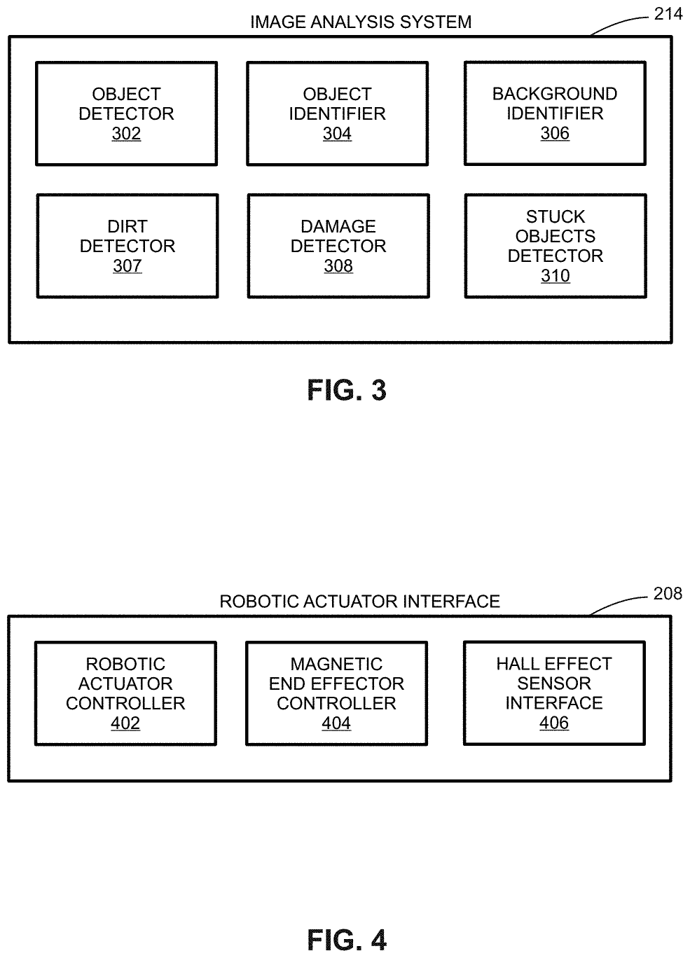

FIG. 3 is a block diagram depicting an embodiment of image analysis system 214. In some embodiments, image analysis system 214 includes an object detector 302 that is configured to process an image captured by imaging system 106 to detect a presence of an object (i.e., an article of cutlery) presented by robotic actuator 104 in field of view 118. Algorithms that may be implemented by the object detector 302 are outlined below.

Once an object is detected, an object identifier 304 determines a type of the object (i.e., the article of cutlery). For example, object identifier 304 may be configured to determine whether the article of cutlery is a fork, a spoon or a knife. Algorithms that may be implemented by the object identifier 304 are outlined below.

In some embodiments, image analysis system 214 includes a background identifier 306 that is configured to perform image processing on an image captured by imaging system 106 to detect, identify and discriminate a background relative to an article of cutlery that is presented in field of view 118 by robotic actuator 104. Background identifier 306 effectively allows image analysis system 214 to distinguish an article of cutlery from background information in an image. In some embodiments, the background may be a predetermined background such as a solid-colored background. In other embodiments, it may not be possible to provide a standard background and the background may contain distracting elements that are rendered in the image. In this case, imaging conditions such as lighting and background associated with imaging system 106 capturing an image of article of cutlery 112 may be controllable. Note that background identification may make image analysis more accurate but may be omitted in some embodiments. For example, one may use a black colored non-reflective surface so that cutlery 112 is more discernible compared to those on a metal workspace surface, which would obscure the edges of the cutlery articles. This improves the accuracy and robustness as well as the confidence of the inference results from the detection and identification models.

A dirt detector 307 and a damage detector 308 included in image analysis system 214 are respectively configured to determine a presence of dirt or damage on an article of cutlery. Examples of dirt include food soils and stains on the article of cutlery after the article of cutlery has been used. Examples of damage on an article of cutlery include bent or broken tines on a fork, or gouges or pitting on a spoon.

In some embodiments, when magnetic end effector 110 attempts to engage an article of cutlery from a collection (plurality) of articles of cutlery, multiple articles of cutlery that are stuck together may be simultaneously engaged by magnetic end effector 110. For example, a blade of a knife may be stuck within the tines of a fork. A stuck objects detector 310 included in imaging system 214 is configured to detect and identify such stuck articles of cutlery.

FIG. 4 is a block diagram depicting an embodiment of robotic actuator interface 208. In some embodiments, robotic actuator interface 208 includes a robotic actuator controller 402 that is configured to transmit positioning and gripping commands to robotic actuator 104. Robotic actuator controller 402 may be programmed with predetermined coordinate positions referenced to a collection of articles of cutlery and field of view 118. Robotic actuator controller 402 may be programmed to issue commands to robotic actuator 104 to move in a proximity of the collection of the articles of cutlery, engage an article of cutlery, and move the article of cutlery into field of view 118. After the article of cutlery has been identified, robotic actuator controller 402 issues a command to robotic actuator 104 to deposit the article of cutlery in a predetermined position with known destination coordinates, which may include depositing the article of cutlery in a predefined orientation.

In some embodiments, robotic actuator interface 208 includes a magnetic end effector controller 404 that is configured to issue commands to magnetic end effector 110. For example, if magnetic end effector 110 includes an electromagnet then magnetic end effector controller 404 issues activate or deactivate commands to magnetic end effector. These activate or deactivate commands either energize or de-energize the electromagnet respectively. In other embodiments, if magnetic end effector 110 includes a permanent magnet then magnetic end effector controller 404 may issue commands to a mechanical apparatus that engages or disengages an article of cutlery using the permanent magnet.

Although embodiments disclosed herein are described as using a magnetic end effector 110, other types of magnetic end effectors may be used in its place, such as mechanical gripper including fingers that may be rotated or moved translationally relative to one another to pinch and release items.

In some embodiments, magnetic end effector 110 includes a Hall effect sensor that is used by silverware identification system 100 to detect whether multiple articles of cutlery have been engaged by robotic actuator 104, as discussed herein. Outputs generated by the Hall effect sensor are received by a Hall effect sensor interface 406 that is included in robotic actuator interface 208. These received outputs from the Hall effect sensor are further processed by processing system 102 to determine whether magnetic end effector 110 has engaged multiple articles of cutlery. In other embodiments, images generated by imaging system 106 are processed by processing system 102 to determine whether magnetic end effector 110 has engaged multiple articles of cutlery. In other embodiments, an inductive sensor may be used in the place of the Hall effect sensor in order to detect presence of multiple articles of cutlery, i.e. an amount of metal present may be sensed by detecting variation in a sensed inductance of an inductive coil incorporated into the magnetic end effector 110. The amount of metal present may then be used to estimate a number of articles of cutlery present, e.g. a predefined mapping between the measured inductance of one or more inductive coils and a number of cutlery present may be determined by measurement and used by the processing system 102 to determine the number of cutlery present for a given resonant frequency. The manner in which the inductive loop, circuit, and resonant frequency sensing is performed may be according to any approach known in the art.

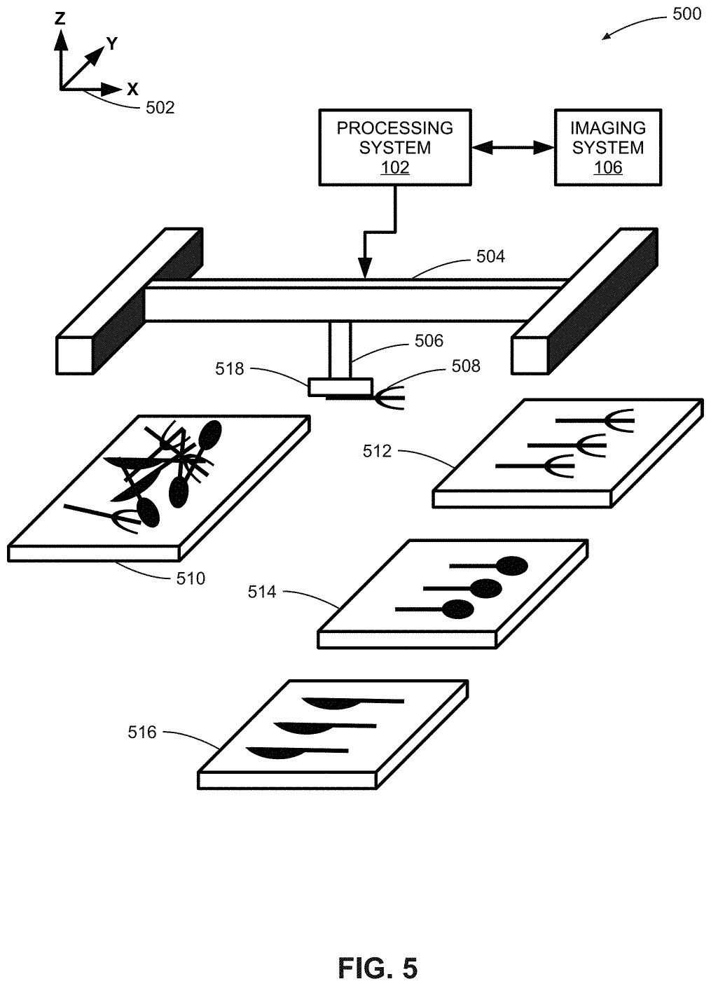

FIG. 5 is a schematic diagram depicting an embodiment of a silverware identification system 500 that is configured to sort articles of silverware. In some embodiments, silverware identification system 500 includes a robotic actuator 506 mounted on a support rail 504, and configured to move in an X-Y plane relative of a coordinate system 502. Robotic actuator 506 includes a magnetic end effector 518 that is configured to move in a Z direction relative to coordinate system 502. In some embodiments, magnetic end effector 518 is a permanent magnet. In other embodiments, magnetic end effector 518 is an electromagnet. An embodiment comprising robotic actuator 506 and support rail 504 may be implemented using an X-Y gantry robot.

In some embodiments, processing system 102 may be configured to issue actuation commands to a combination of robotic actuator 506 and magnetic end effector 518, where actuation commands include positioning commands for robotic actuator 506 relative to coordinate system 502, and activation or deactivation commands associated with magnetic end effector 518.

In some embodiments, processing system 102 commands robotic actuator 506 to move in an X-Y direction, to a proximity of a collection of articles of cutlery placed on a work surface 510. In some embodiments, the collection of articles of cutlery may be in a cutlery bin (not shown). When robotic actuator 506 is in a proximity of the collection of articles of cutlery placed on work surface 510, processing system 102 commands robotic actuator 506 to move magnetic end effector 518 in a Z-direction referenced to coordinate system 502, towards the collection of articles of cutlery placed on work surface 510. Processing system 102 then issues a command to activate magnetic end effector 518, so that magnetic end effector 518 engages and grips a random, unidentified article of cutlery from the collection of articles of cutlery placed on work surface 510. For example, in FIG. 5, magnetic end effector 518 is shown to have engaged an article of cutlery 508 (in this case, a fork). In some embodiments, magnetic end effector 518 may include a magnet with multiple poles (for example, a cube magnet) that allows article of cutlery 508 to align in a specific spatial orientation.

In some embodiments, processing system 102 commands robotic actuator 506 to spatially orient article of cutlery 508 so that article of cutlery 508 is in a field of view of imaging system 106 that is communicatively coupled with processing system 102. Processing system 102 then commands imaging system 106 to capture an image of article of cutlery 508 and transmit the image to processing system 102. Processing system 102 processes the image to identify a type of article of cutlery 508. Once a type of an article of cutlery 508 has been identified by processing system 102, processing system 102 commands robotic actuator to move along support rail 504 towards and deposit the article of cutlery on one of a workspace 512 that contains forks, a workspace 514 that contains spoons, and a workspace 516 that contains knives. In FIG. 5, article of cutlery 508 is a fork; hence processing system 102 commands robotic actuator to deposit article of cutlery 508 on workspace 512. This process is essentially a sorting process, where an article of cutlery is placed along with articles of cutlery of an identical type after the article of cutlery has been identified. As noted above, grasping and depositing of articles of cutlery may be performed using rotating or translationally actuated mechanical grippers.

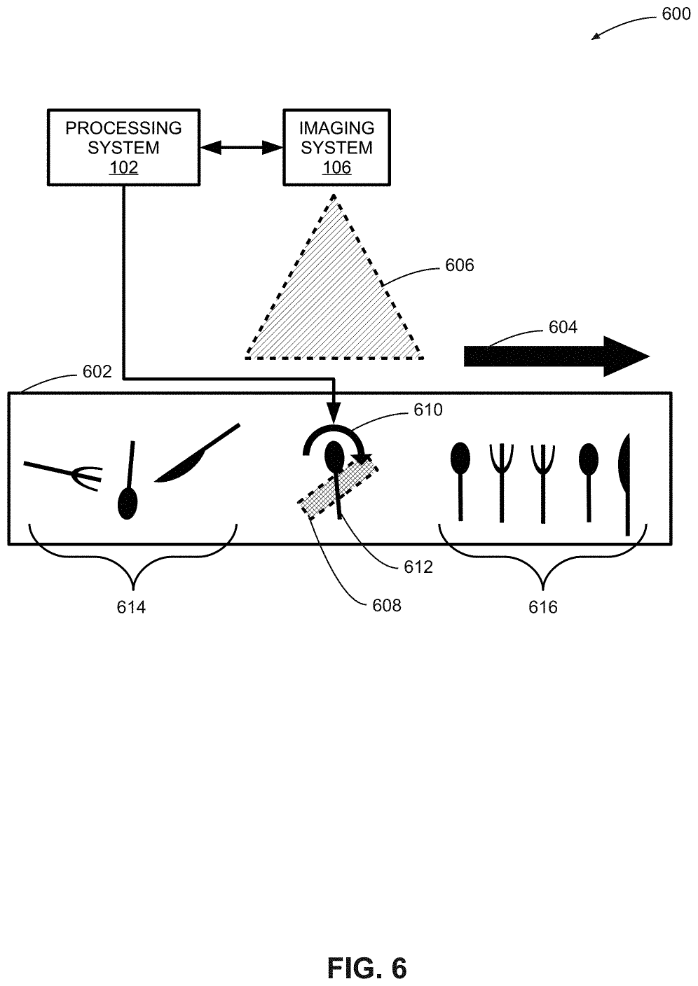

FIG. 6 is a schematic diagram depicting an embodiment of a silverware identification system 600 that is configured to reorient articles of silverware. In some embodiments, a conveyor belt 602 is configured to convey articles of cutlery 614 along a direction 604. Articles of cutlery 614 are usually disposed in random orientations on conveyor belt 602 as shown in FIG. 6. In some embodiments, articles of cutlery 614 may be placed on conveyor belt 602 by a combination of robotic actuator 104 and magnetic end effector 110 as described herein. In particular embodiments, imaging system 106 is configured to image an article of cutlery 612 as it travels along conveyor belt 602, when article of cutlery 612 is in a field of view 606 of imaging system 106. Processing system 102 communicatively coupled to processing system 102 receives this image, identifies the article of cutlery, and determines an orientation of article of cutlery 612 relative to conveyor belt 602. Responsive to determining this orientation, processing system 102 issues a command to a magnet 608, where magnet 608 is disposed below conveyor belt 602, and magnet 608 is configured to rotate about an axis of rotation that is perpendicular to a plane containing conveyor belt 602. Rotation 610 of magnet 608 is accomplished via conveyor belt magnet driver 216. This rotation of magnet 608 corresponds to article of cutlery 612 being within a magnetic field generated by magnet 608 where the magnetic field is strong enough to rotate article of cutlery 612 about the axis of rotation of magnet 608 when magnet 608 is rotated about this axis.

In some embodiments, imaging system 106 continues to capture images of article of cutlery 612; processing system 102 receives these images and processes these images to determine and track an orientation of article of cutlery 612 as it rotates under the influence of the magnetic field of rotating magnet 608. When article of cutlery 612 is in a predetermined final orientation as determined by processing system 102, processing system 102 stops the rotation of magnet 608, and article of 612 assumes a final orientation relative to conveyor belt 602. Conveyor belt 602 then moves article of cutlery 612 away from field of view 606 to make way for a subsequent article of cutlery. Conveyor belt 602 moves away a set of oriented articles of cutlery 616 that are now arranged substantially parallel to one another in a specified orientation as illustrated in FIG. 6. Robotic actuator 104 and magnetic end effector 110 can now be used to sort an article of cutlery from oriented articles of cutlery 616 into an appropriate collection of like articles of cutlery.

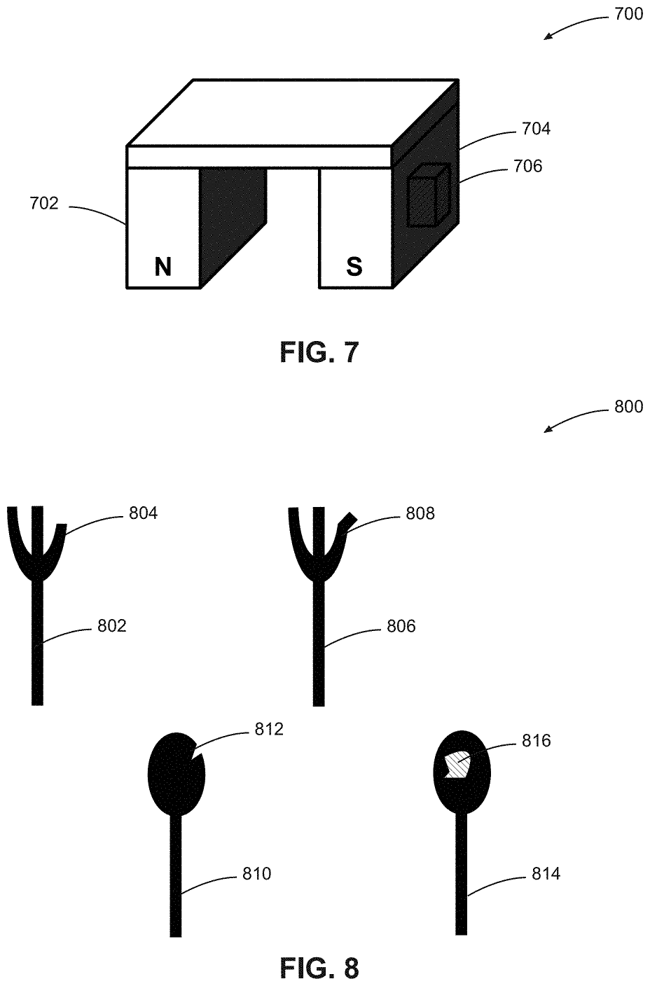

FIG. 7 is a schematic diagram depicting an embodiment of a magnetic end effector 700. In some embodiments, magnetic end effector 700 is a cube magnet as illustrated in FIG. 7. Magnetic end effector 700 is a multi-pole magnet that includes a North pole 702 and a South pole 704. In some embodiments, magnetic end effector 700 is comprised of an electromagnet. In other embodiments, magnetic end effector 700 is comprised of permanent magnets. This arrangement of multiple poles forces an article of cutlery engaged by magnetic end effector 700 to align itself in a specific orientation. For example, an article of cutlery engaged by magnetic end effector 700 would align itself longitudinally such that one end of the article of cutlery is gripped by North pole 702, and the other end of the article of cutlery is gripped by South pole 704. In some embodiments, the magnetic end effector 700 includes two magnets oriented in opposite directions with a ferromagnetic plate coupling the south pole of one magnet to the north pole of the other magnet with the ends of the magnets opposite the plate being used to engage items. Including such constraints that allow an article of cutlery to align itself in a specific orientation reduces a number of degrees of freedom that are required by any sorting apparatus associated with silverware identification system 100.

In some embodiments, magnetic end effector 700 includes a Hall effect sensor 706 that is configured to detect a perturbation or deviation in a magnetic field generated between North pole 702 and South pole 704. When magnetic end effector 700 does not engage an article of cutlery, this magnetic field is not perturbed. When a single article of cutlery is engaged by magnetic end effector 700, the magnetic field between North pole 702 and South pole 704 is perturbed. This perturbation is detected by Hall effect sensor 706. In some embodiments, Hall effect sensor 706 is configured to transmit signals associated with perturbations in the magnetic field between North pole 702 and South pole 704 to Hall effect sensor interface 406.

In some embodiments, if magnetic end effector 700 engages multiple articles of cutlery, a corresponding perturbation in the magnetic field between North pole 702 and South pole 704 is different from the perturbation in this magnetic field corresponding to when a single article of cutlery is engaged by magnetic end effector 700. Hall effect sensor 706 corresponding outputs a different signal when multiple articles of cutlery are engaged as compared to when a single article of cutlery is engaged. This difference in signals output by Hall effect sensor 706 is detected by processing system 102 to determine whether multiple articles of cutlery are engaged by magnetic end effector 700. In an event that multiple articles of cutlery are engaged by magnetic end effector 700, processing system 102 may command magnetic end effector 700 to release the multiple articles of cutlery and attempt to re-engage a single article of cutlery.

FIG. 8 is a schematic diagram depicting an example 800 of damaged or dirty articles of cutlery. Example 800 depicts a fork 802 with a broken tine 804, a fork 806 with a bent tine 808, a spoon 810 with a gouge 812, and a spoon 814 with a soil, stain or damaged finish 816. The articles of cutlery depicted in example 800 may be encountered in a restaurant setting. In some embodiments, dirt detector 307 and damage detector 308 may be configured to identify the kinds of dirt and damage presented in example 800. Automatic detection of such dirt and damage reduces a burden on manual labor to identify and remove such articles of cutlery from a collection of articles of cutlery in service.

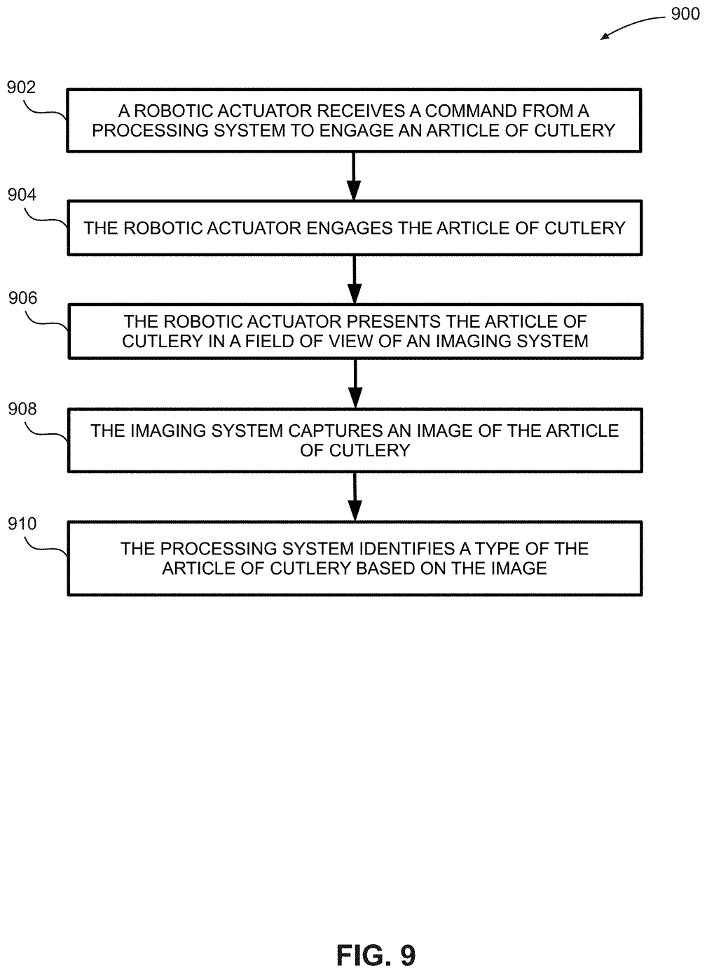

FIG. 9 is a flow diagram depicting an embodiment of a method 900 to identify an article of cutlery. At 902, a robotic actuator (such as robotic actuator 104) receives a command from a processing system to engage an article of cutlery. At 904, the robotic actuator engages the article of cutlery. In some embodiments, the robotic actuator engages the article of cutlery using a magnetic end effector such as magnetic end effector 110. In other embodiments, the robotic actuator engages the article of cutlery using a mechanical gripper end effector. At 906, the robotic actuator presents the article of cutlery in a field of view of an imaging system such as imaging system 106. Next, at 908, the imaging system captures an image of the article of cutlery. Finally, at 910, the processing system identifies a type of the article of cutlery based on the image. The detection of cutlery and classification of its type may be done by a single convolution neural network (CNN) configured according to any approach known in the art.

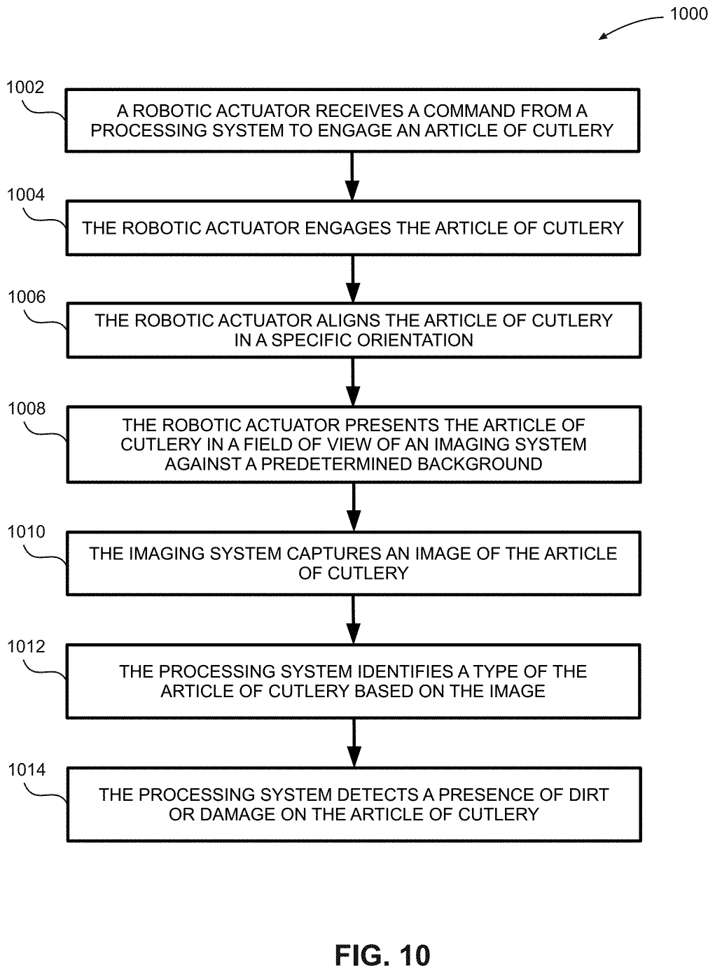

FIG. 10 is a flow diagram depicting an embodiment of a method 1000 to detect a presence of dirt or damage on an article of cutlery. At 1002, a robotic actuator (such as robotic actuator 104) receives a command from a processing system to engage an article of cutlery. At 1004, the robotic actuator engages the article of cutlery. In some embodiments, the robotic actuator engages the article of cutlery using a magnetic end effector such as magnetic end effector 110. At 1006, the robotic actuator aligns the article of cutlery in a specific orientation. At 1008, the robotic actuator presents the article of cutlery in a field of view of an imaging system such as imaging system 106, against a predetermined background. Next, at 1010, the imaging system captures an image of the article of cutlery. At 1012, the processing system identifies a type of the article of cutlery based on the image. In some embodiments, aligning the article of cutlery in a specific orientation by the robotic actuator and the predetermined background allow the processing system to detect and identify the article of cutlery with a higher confidence level. Finally, at 1014, the processing system detects a presence of dirt or damage on the article of cutlery based on the image. This may include another stage of image classification run on a bounding box of the dirt or damage found by an object detector.

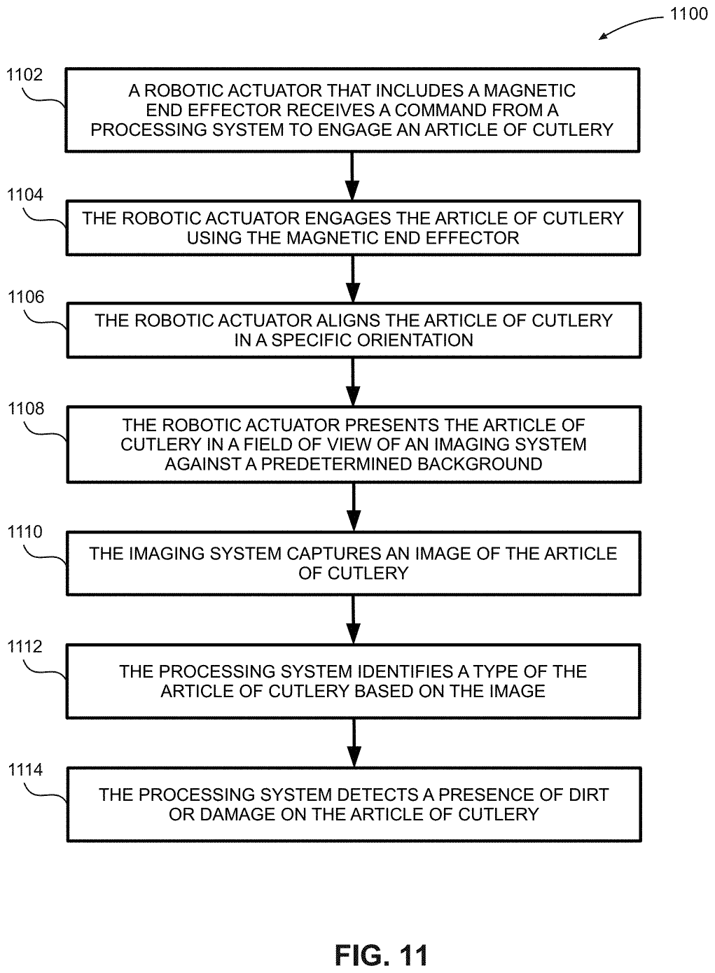

FIG. 11 is a flow diagram depicting an embodiment of another method 1100 to detect a presence of dirt or damage on an article of cutlery. At 1102, a robotic actuator (such as robotic actuator 104) that includes a magnetic end effector (such as magnetic end effector 110) receives a command from a processing system to engage an article of cutlery. At 1104, the robotic actuator engages the article of cutlery using the magnetic end effector. At 1106, the robotic actuator aligns the article of cutlery in a specific orientation. At 1108, the robotic actuator presents the article of cutlery in a field of view of an imaging system such as imaging system 106, against a predetermined background. Next, at 1110, the imaging system captures an image of the article of cutlery. At 1112, the processing system identifies a type of the article of cutlery based on the image. In some embodiments, aligning of the article of cutlery in a specific orientation by the robotic actuator and the predetermined background allow the processing system to detect and identify the article of cutlery with a higher confidence level. Finally, at 1114, the processing system detects a presence of dirt or damage on the article of cutlery based on the image. This may include another stage of image classification run on a bounding box of the dirt or damage found by an object detector.

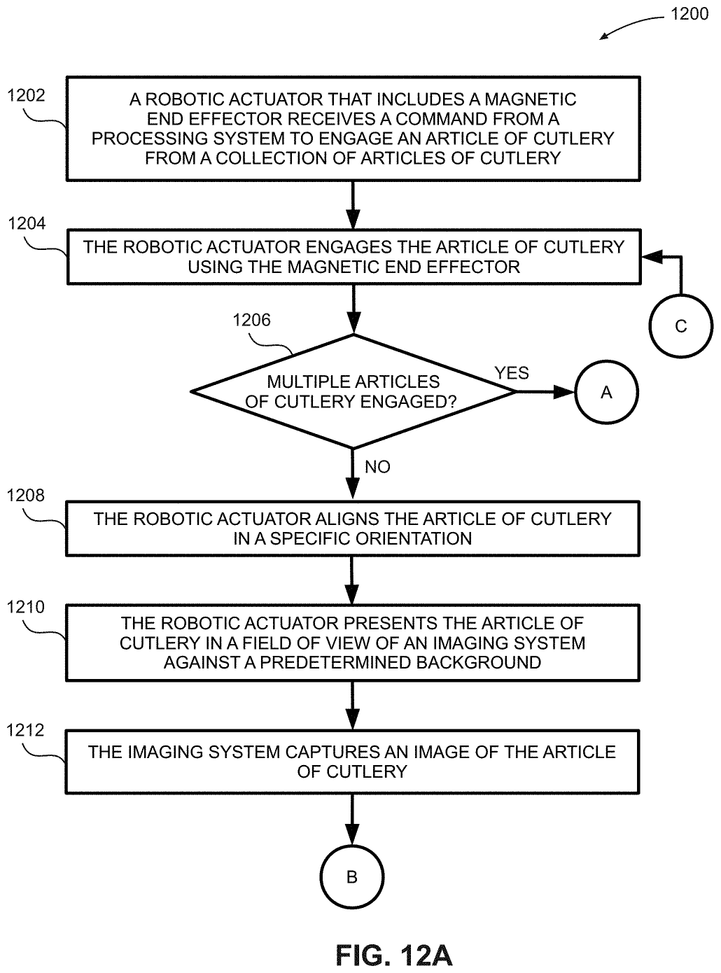

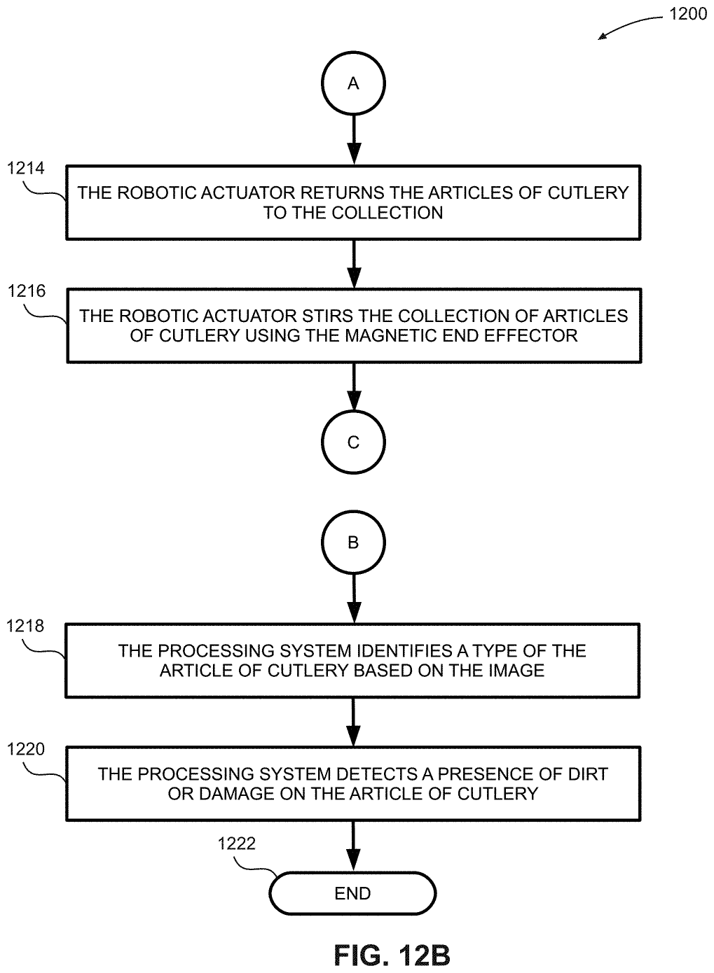

FIG. 12 A is a flow diagram depicting an embodiment of a method 1200 to grip a single article of cutlery from a collection using a magnetic gripper. At 1202, a robotic actuator (such as robotic actuator 104) that includes a magnetic end effector (such as magnetic end effector 110) receives a command from a processing system to engage an article of cutlery. At 1204, the robotic actuator engages the article of cutlery using the magnetic end effector. At 1206, the method checks to determine whether multiple articles of cutlery are engaged. In some embodiments, an engagement of multiple articles of cutlery may be determined by a Hall effect sensor as described herein. In other embodiments, an engagement of multiple articles of cutlery may be determined by image processing techniques.

If the method determines that multiple articles of cutlery are engaged, then the method goes to A, with a continued description in the description of FIG. 12B. If, at 1206, the method determines that multiple articles of cutlery are not engaged, then the method goes to 1208, where the robotic actuator aligns the article of cutlery in a specific orientation. At 1210, the robotic actuator presents the article of cutlery in a field of view of an imaging system such as imaging system 106, against a predetermined background. Next, at 1212, the imaging system captures an image of the article of cutlery. The method then goes to B, with a continued description in the description of FIG. 12B.

FIG. 12B is a continued description of method 1200. Starting at A, the method goes to 1214, where the robotic actuator returns the articles of cutlery to the collection. In some embodiments, the articles of cutlery are returned by disengaging the articles of cutlery from the magnetic end effector. Next, at 1216, the robotic actuator stirs the collection of articles of cutlery using the magnetic end effector. In some embodiments, the stirring is accomplished by using the imaging system in tandem with the magnetic end effector, where the magnetic end effector is inserted into the collection of articles of cutlery, and the articles of cutlery are stirred using the magnetic end effector, e.g. circular motion, back and forth motion, etc. This stirring action may free, for example, articles of cutlery such as forks that are stuck together, or forks that are stuck to knives. The method then goes to C, where it returns to 1204. Note that the stirring of step 1216 may be performed using an end effector other than the magnetic end effector, e.g. a non-magnetic rod, planar member, multi-tined rake-like structure, pinching gripper as discussed above, or some other shape.

On the other hand, if method 1200 is at B, the method goes to 1218, where the processing system identifies a type of the article of cutlery based on the image. In some embodiments, aligning of the article of cutlery in a specific orientation by the robotic actuator and the predetermined background allow the processing system to detect and identify the article of cutlery with a higher confidence level. Finally, at 1220, the processing system detects a presence of dirt or damage on the article of cutlery based on the image. The method 1200 then terminates at 1222.

Note that step 1218 may be another application of an object detector that detects an article of cutlery, finds a bounding box associated with the article of cutlery, and classifies the article of cutlery to obtain a label representing the type of article of cutlery. The dirt and damage detection of step 1220 may also be another application of dirt detection previously described for the imaging blocks of FIG. 3.

For a pile of many articles of cutlery, the object detector may or may not locate graspable cutlery pieces. Or even when the object detector produces bounding boxes with some cutlery articles, those pieces may be buried under other pieces and the bounding boxes are associated with very low confidence scores. Either when the bounding boxes are associated with confidence scores below a predetermined threshold or when there are no bounding boxes, the processing system 102 may instruct the robotic actuator 104 to stir the pile of cutlery articles and subsequently execute the object detector on the stirred pile. This step could be repeated until there are cutlery articles detected that produce bounding boxes with high confidence scores.

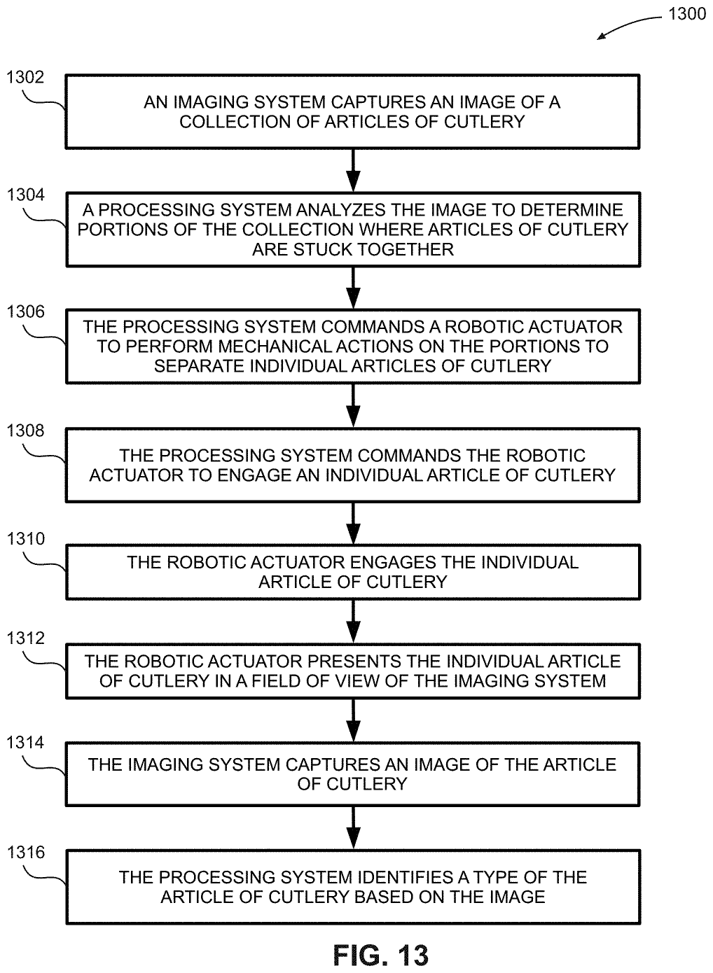

FIG. 13 is a flow diagram depicting an embodiment of a method 1300 to identify a type of an article of cutlery. At 1302, an imaging system such as imaging system 106 captures an image of a collection of articles of cutlery. Next, at 1304, a processing system such as processing system 102 receives this image from the imaging system, and analyzes the image to determine portions of the collection where articles of cutlery are stuck together. Determining the portions of the collection where articles of cutlery are stuck together may be performed as described above with respect to the stuck object detector 310 in FIG. 3.

The stuck object detector 310 may be implemented in multiple ways. In one embodiment, there is a classification model. The classification model receives a region of an image in which the stuck objects are shown. Such a region is an output from the object detection in the form of bounding box. The model generates a predicted label with two categories. One indicates that the objects in the input image are not stuck together or there is only a single object and the other indicates that the objects are stuck together. Examples of classification models include, but are not limited to, the deep CNN architectures such as ResNets, DenseNets, SENets, and their variations.

Next, at 1306, the processing system commands a robotic actuator to perform mechanical actions on the portions to separate individual articles of cutlery. For example, the processing system may command the robotic actuator to stir the articles of cutlery as described in method 1200. Or, the processing system may command the robotic actuator to engage the articles of cutlery that are stuck together and mechanically manipulate the articles of cutlery to separate them. In some embodiments, this mechanical manipulation is done by physically agitating or shaking the articles of cutlery that are stuck together. In other embodiments, the robotic actuator may use different kinds of grippers to separate the articles of cutlery that are stuck together.

At 1308, the processing system commands the robotic actuator to engage an individual article of cutlery. In some embodiments, the robotic actuator engages 1310 an individual article of cutlery using a magnetic end effector such as magnetic end effector 110. At 1312, the robotic actuator presents the article of cutlery in a field of view of the imaging system. Next, at 1314, the imaging system captures an image of the article of cutlery. Finally, at 1316, the processing system identifies a type of the article of cutlery based on the image. Step 1316 may include performing the functions of the object identifier 304 with respect to the image as described above with respect to FIG. 3.

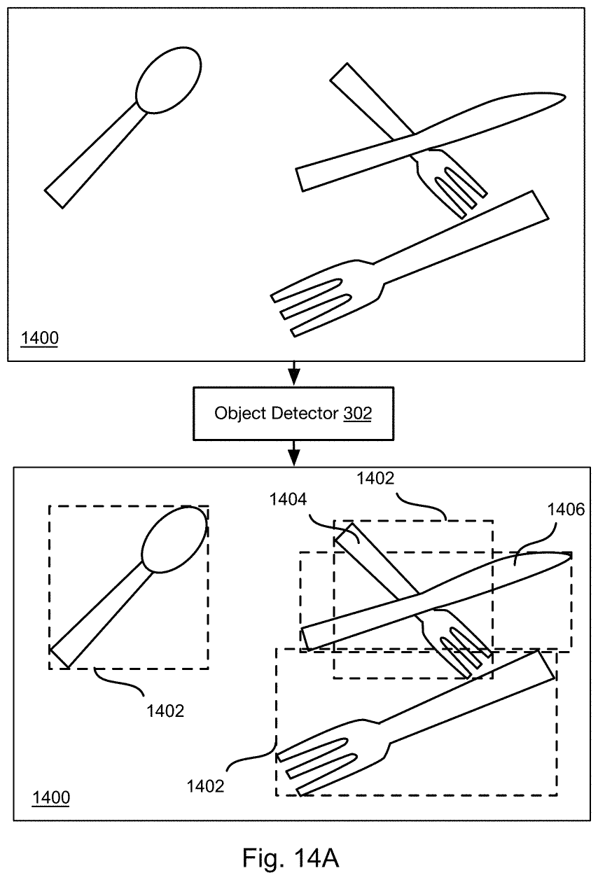

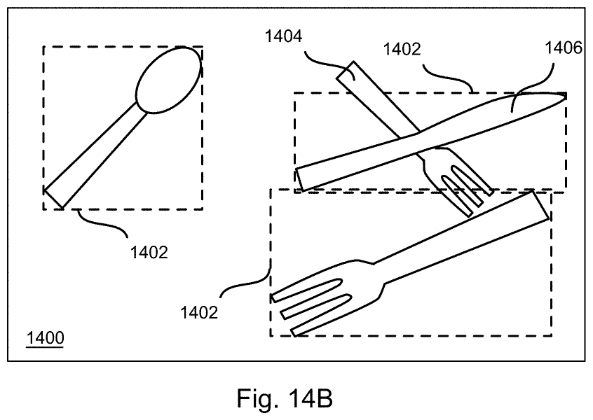

FIG. 14A illustrates an example approach for performing object detection according to any of the foregoing embodiments. In particular, the approach of FIG. 14 may be implemented by the object detector 302 referenced above. As shown in FIG. 14, an image 1400 may be analyzed using a machine vision algorithm to perform object identification, or both object identification and classification. The machine vision algorithm may be a convolution neural network (CNN) or other machine learning algorithms trained to object identification, or both object identification and classification. Alternatively, a first CNN may be trained and used to perform object identification and a second CNN may be trained and used to classify objects identified by the first CNN.

For example, an image 1400 may be received by the processing system 102 from the imaging system 106. The object detector 302 identifies two-dimensional (2D) bounding boxes 1402 of objects present in the image 1400 and classifies the object within each bounding box, such as a fork, spoon, knife, or other item of cutlery.

The input to the object identifier 304 may be composed of one or more images 1400 and the model produces 2D bounding boxes of the cutlery articles of interest in the form of the center, width, and height of the 2D bounding box, e.g. these values may be represented as pixel coordinates within the image 1400. Note that the sides of the bounding box 1402 may be parallel to the sides of the image 1400. Other references to a 2D bounding box herein below may be defined in a similar manner. The object detector model 302 can be a single-stage or two or more staged CNN such as Faster R-CNN, SSD, YOLOv3 and Mask R-CNN.

Each bounding box may also have a confidence score generated by the machine vision algorithm. The confidence score may indicate a probability that an object is present in the 2D bounding box and may additionally or alternatively indicate a confidence that a classification of the object present in the 2D bounding box is correct.

The object detector 302 may be trained before it is deployed for making online inference in the system 100. The data for training may include training images in which articles of cutlery are placed whose bounding boxes for each object along with the class label of the object are annotated by humans. Both the bounding boxes and the image are input to the object detector 302 from which the estimated 2D bounding boxes 1402 are produced. The object detector 302 is trained until the magnitude of the difference between the estimated bounding boxes 1402 and the human annotated bounding boxes becomes lower than a specified threshold. The magnitude of the difference may be measured by a mean squared difference of the two bounding boxes. The minimization may be performed by stochastic gradient descent algorithms or their variants. There exist several popular software libraries that may be used to perform training, such as PyTorch and TensorFlow.

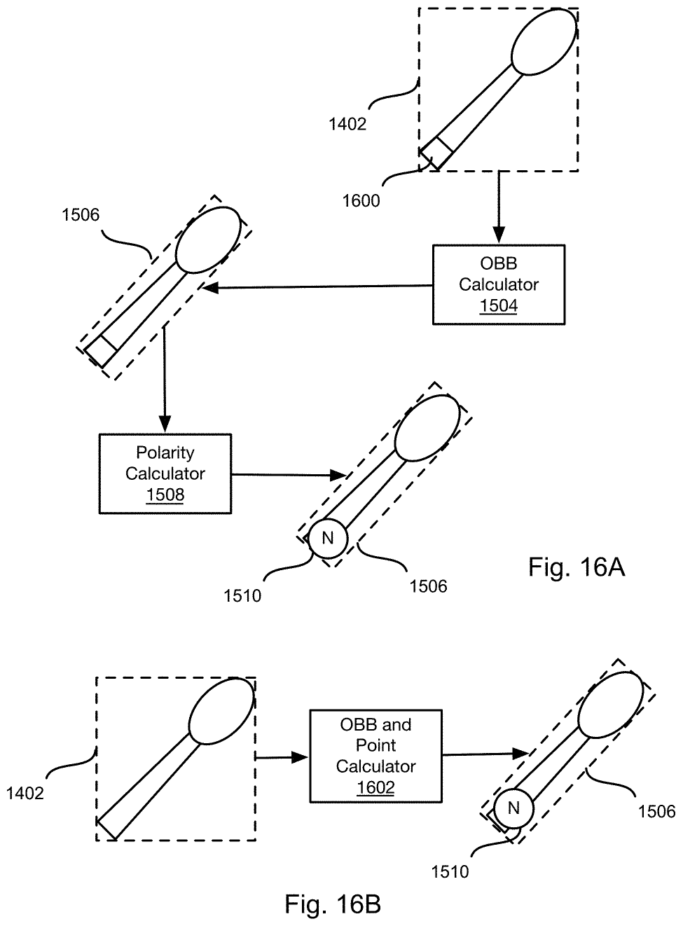

The imaging system 106 (e.g., cameras) may be calibrated relative to the robotic actuator 104. The mathematical transformation between the imaging system 106 and the robotic actuator 104 may be generated as a result of calibration. Such a calibration is known as robot hand-eye coordination and may be performed using software libraries that are widely available. The calibration output may be used to map image pixel coordinates in the image 1400 to physical coordinates in the workspace 114 and to position and orient the robotic actuator such that the actuator can grasp the target cutlery at an intended location with a desired orientation. The orientation of an item of cutlery may be determined using the approach described below with respect to FIGS. 15 and 16.

The object detector may be trained in various ways to handle the case of cluttered cutlery in which items may be on top of one another. FIG. 14A shows a first case in which all cutlery is attempted to be identified and associated with a bounding box 1402. Accordingly, fork 1404, which is partially occluded by knife 1406 is still associated with a bounding box 1402.

In another approach, only the articles of cutlery that are in the pile and are not occluded by other articles of cutlery are labeled with a bounding box and used to train a detector. This is shown in FIG. 14B in which fork 1404 is not associated with a bounding box 1402 inasmuch as it is occluded by knife 1406. Accordingly, the confidence associated with a bounding box 1402 inferred by the detector will also indicate a probability of success in grasping and holding the article of cutlery using the robotic actuator whether it is magnetic or other types of grasping mechanisms.

In yet another embodiment, only the articles of cutlery that are not buried in the pile and can be manipulated are labeled with a bounding box and used to train a detector. For example, in the example of FIG. 14A, fork 1404 could be associated with a bounding box 1402 if the object detector 302 classified it as being pickable by the robotic actuator 104 despite being occluded by knife 1406. In contrast, other articles of cutlery may be buried in other articles and classified as non-pickable by the robotic actuator or likely to be dropped while being manipulated or moved to other parts of the pipeline. In addition, the object detector 302 can produce a class label indicating that no cutlery represented in an image 1400 can be manipulated with high probability of success of grasping and holding.

Referring to FIG. 15, in some embodiments, image or instance segmentation may be used as part of the function of the object detector 304. For example, a portion of the image 1400 within the 2D bounding box 1402 of an article of cutlery may be processed by a mask calculator 1500 to obtain a pixel-level mask 1502 of the object indicating the tight boundary of the article of cutlery. This may be performed using a CNN trained to perform that function or by using another machine vision algorithm.

Then, an oriented bounding box (OBB) calculator 1504 uses geometric computer vision to find the an OBB 1506 that tightly encloses the mask 1502. One way to find the OBB 1506 for the mask is to use the function minAreaRect from the open source computer vision library, OpenCV. This function utilizes a computational geometry method called rotating calipers to find the rectangle with the smallest area that encloses the given mask 1506. Given the OBB 1508, a polarity calculator 1508 can be utilized to identify the polarity 1510 of the cutlery enclosed in the OBB 1506. For example, this may include determining the angle of the OBB 1506 using the OBB calculator 1504 followed by determining the polarity of the cutlery within the OBB 1506 to avoid confusion as to the orientation of the article of cutlery in the OBB 1506. For example, in the illustrated example, polarity 1510 output by the polarity calculator 1508 indicates which end of the OBB 1506 is closest to the handle of the illustrated spoon. In other examples, polarity calculator 1508 indicates which end of the OBB 1506 is closest to the handle of a fork, knife, or other type of cutlery. In some embodiments, the polarity calculator 1508 determines the end of the OBB closest to the bowl of a spoon, tines of a fork, blade of a knife, etc., rather than the end closest to the handle. The polarity calculator may be a CNN trained to identify polarity or a machine vision algorithm that compares predefined masks for different types of cutlery to the mask 1506 to estimate the polarity of the cutlery represented by the mask 1506.

In an alternative embodiment, the OBB 1506 of cutlery in a bounding box 1402 is calculated directly by the object detector 302, i.e. the object detector 302 is or includes a CNN trained to perform that function without first computing a mask 1502. Accordingly, the detector would propose an OBB 1506 that may be represented as (x, y, theta, height, width) with theta representing the angle of the OBB. The polarity calculator 1508 may then be a simple classifier that identifies the polarity as discussed above except that it is trained to operate on images of cutlery rather than masks of images.

Referring to FIG. 16A, in some embodiments cutlery includes a mark 1600, e.g. a red stripe or other type of mark on the handle. Accordingly, the polarity calculator 1508 may be a CNN trained to identify the mark 1600 in an image and output the polarity 1510 as the end of the OBB 1506 closest to the mark 1600.

Note that the approach described above for determining the OBB 1506 and polarity 1510 of an article of cutler may be used instead of performing oriented and ordered placement of cutlery during sorting in other embodiments disclosed herein (see FIGS. 5, 6, and 10-12). For example, by determining the OBB and polarity as described above, the robotic actuator 104 does not need to rely on a mechanical component or accurate robotic motion to place an article of cutlery in a specific orientation. Instead, the article of cutlery is randomly placed and the orientation and polarity of the article of cutlery may be determined as described above when grasping the article of cutlery.

Once the OBB 1506 and polarity of an item of cutlery is known, the processing system 102 may control the robotic actuator 104 to grasp and move the article of cutlery according to the methods described above based on the known orientation and polarity, e.g. engaging the end effector with the handle of the article of cutlery.

In another alternative embodiment, an OBB 1506 and polarity 1510 are determined by the detector 302 as shown in FIG. 16B. The OBB and point calculator 1602 may be implemented as a CNN trained to produce both an OBB 1506 and a point 1506 indicating polarity, such as a point indicating where the handle of the cutlery is relative to the OBB 1506, thus there is no need for an extra component 1508 to ascertain the polarity.

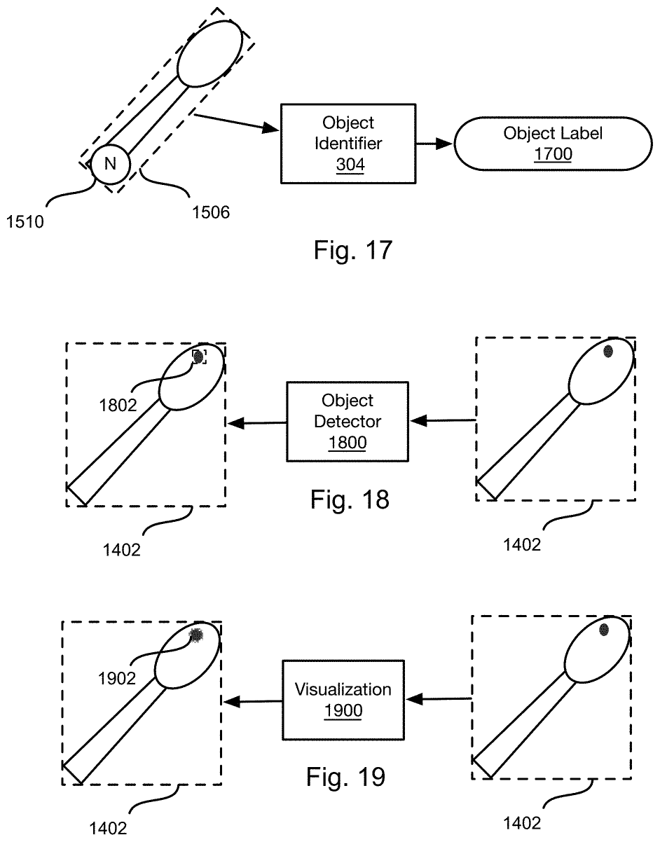

FIG. 17 illustrates operation of the object identifier 304 that may be used in any of the methods described above. There may be multiple types of forks, spoons, and knives, such as different types of forks, serving utensils, cutlery from different manufacturers. Accordingly, the classification of the object identifier 304 may be more granular and classify cutlery as being either a fork, spoon, or knife and further classify it as being of a particular size and/or from a particular manufacturer. For example, small teaspoons may be a first category, large spoons may be a second category, small forks may be a third category, and so on.

In some embodiments, identification of 2D bounding boxes 1402 of objects may be performed using a first CNN trained to perform that task and classification of the object enclosed by a 2D bounding box may be performed by a second CNN trained to perform that task. Multiple second CNNs may be used, each second CNN trained to output whether a particular type of cutlery is present. Alternatively, a single CNN may be trained to both detect and classify cutlery and thus function as both the object detector 302 and the object identifier 304.

The output of the object identifier 304 may be an object label 1700 for each bounding box 1402 that indicates the classification of the cutlery present in the bounding box 1402. The object label 1500 may further include a confidence score indicating a probability of accuracy of the label.

The object identifier 304 may be implemented in the form of an image classifier based on convolutional neural network (CNN) models including, but not limited to, ResNets, DenseNets, SENets, and their variants. The input to the object identifier 304 may include one or more images of an item of cutlery which are then processed the CNN models in order to infer one or more classifications. In particular, bounding boxes 1402 of an item of cutlery form one or more cameras may be processed in order to classify the item of cutlery represented in the one or more bounding boxes 1402.

These CNN models may be trained in a similar manner to the object detector 302 using software libraries such as PyTorch or TensorFlow. The data for training the models may include of images of cutlery articles annotated with the category labels (e.g., large fork or a number that represents such a class or category) of cutlery represented in the images. When the model is deployed in the system 100 to generate an inference result, the input to such a model may be a (cropped) image region that contains only a single article of cutlery, i.e. a single bounding box 1402.

In some embodiments, the input to the object identifier 304 is the portion of an image in the OBB 1506 of an item of cutlery either with or without annotation with the polarity 1510. For example, the x, y, height, width, and theta values defining the OBB 1506 may be input along with the image 1400 to the object identifier, which then classifies the portion of the image enclosed by the OBB 1506.

FIGS. 18, 19 and 20 illustrate various approaches for detecting dirt or damage to cutlery that may be used in any of the foregoing embodiments. In particular, the operation of the dirt detector 307 and damage detector 308 may be according to the approaches shown in any of FIGS. 18, 19, and 20. In the following description “anomaly” shall be understood to refer to either dirt or damage on an item of cutlery.

Referring to FIG. 18, in some embodiments, the bounding box 1402 of an item of cutlery, such as a bounding box identified according to the approach of FIG. 14, may be input to another object detector 1800. Note that in the following description of FIGS. 18, 19, and 20 the bounding box 1402 may be substituted for the OBB 1506 of an item of cutlery as described above.

The object detector 1800 may be a machine vision algorithm trained to identify a particular type of anomaly or multiple types of anomalies. The machine vision algorithm may be a CNN or other type of machine learning algorithm. The CNN may be trained to both identify and classify anomalies. Alternatively, a first CNN may be trained to identify 2D bounding boxes of anomalies and a second CNN may be trained to label each 2D bounding boxes with the anomaly bounded by it. Note that multiple second CNNs may be used, each second CNN trained to output whether a particular type of anomaly is present in a 2D bounding box.

The output of object detector 1800 is a 2D bounding box 1802 around any anomalies detected. Each 2D bounding box may be labeled with a type of the anomaly (damage, dirt, type of contaminant, type of damage) bounded by the 2D bounding box.

The object detector 1800 may be implemented as one or both of detectors and classifiers. The object detector 1800 may be trained in an identical way to that used for training object detectors 302 and object identifiers 304. When the models of the object detector 1800 are embodied as classifiers, the input to such models is an image region containing only one piece of cutlery, often produced by an object detector 302 in an earlier stage (e.g., area in bounding box 1402 or OBB 1506. The output from such models is a label representing whether the article of cutlery in the input image is clean, dirty, or damaged in the simplest level. In an alternative embodiment, the labels can be more fine-grained. For example, the labels could be clean, modestly dirty, very dirty to suggest the amount of additional cleaning required. Similarly, there can be a variety of types of damages such as bent, broken tines (for fork), scratches, and etc. to inform and suggest further actions to the end users.

When the object detector 1800 is a detector rather than (or in addition to) a classifier, the models again receive a region of the image which contains only one piece of cutlery. The output in this case is a set of bounding boxes 1802 that show dirty or damaged spots and each box is associated with a label whether it is a dirt or a damage or possibly both. Another embodiment, similarly to the classifier models, may have more fine-grained labels such as the type of damages (e.g., broken tines). These outputs could be used to guide additional user actions such as further cleaning, discarding, and further repair.

Referring to FIG. 19, in an alternative approach a visualization algorithm 1900 performs anomaly detection on a bounding box 1402 of an article of cutlery (such as identified according to the approach of FIG. 14) and generates a visualization 1902 of the anomaly, such as superimposed on the location of the anomaly.

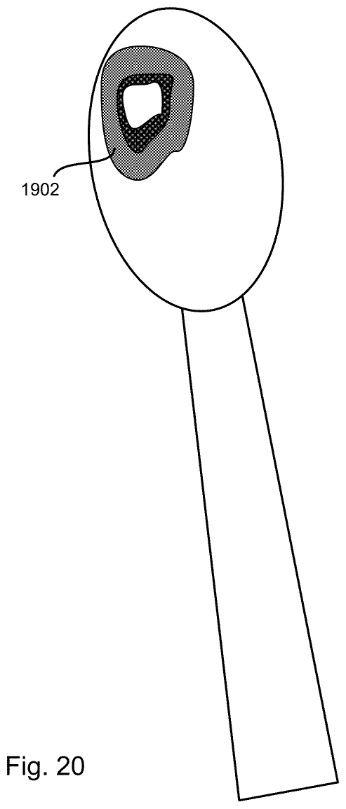

For example, as shown in FIG. 20, the visualization 1902 may be a heat map 1902 in which a color selected for a pixel indicates a probability that an anomaly is located at that pixel position, for example, colors may be in order of probability represented: red, orange, green, and blue (or some other list) where red indicates high probability of an anomaly being present and blue indicates a low probability of an anomaly being present. Of course, other representations may be used, such as different shades of gray indicating different probabilities of an anomaly being present.

In some embodiments, the visualization algorithm 1900 is implemented as a neural network class activation map visualization tool such as Grad-CAM(++), which produces the heat map 1902. The heat map 1902 may then be used to infer the sizes of dirty spots which are approximately proportional to those of the hot spots in the heat map 1902.

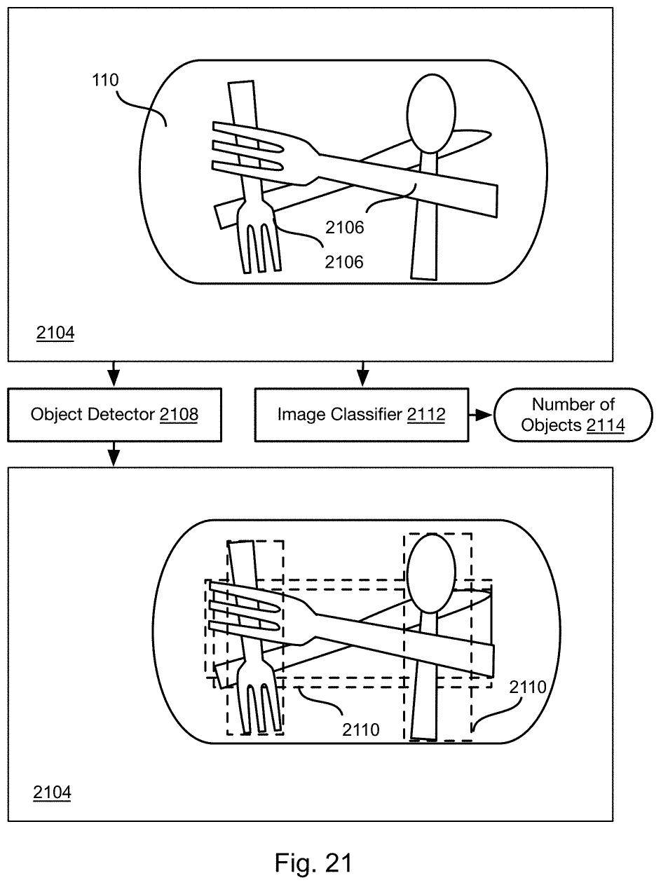

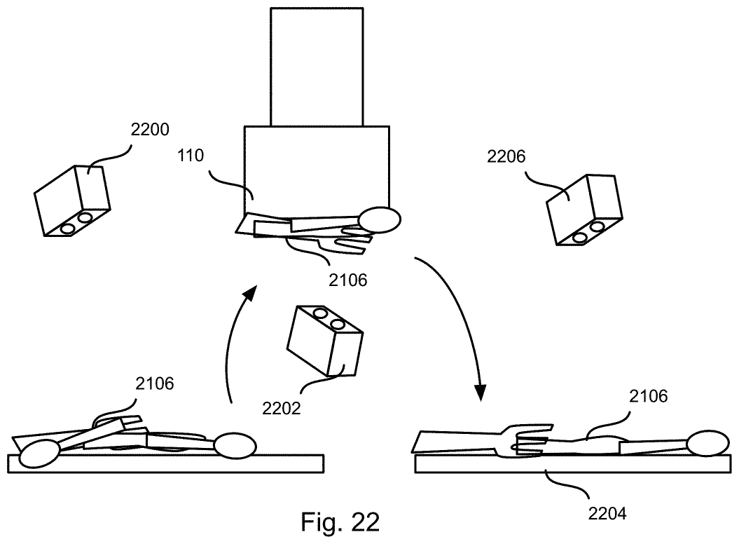

Referring to FIGS. 21 and 22, the illustrated approach may be used to handle the case of multiple items of cutlery. In particular, the approach of FIGS. 21 and 22 may be used in the place of the stirring approach of FIG. 12B (see discussion of steps 1214 and 1216).

As shown in FIG. 21, the end effector 110 may be engaged with a cluster of cutlery, i.e. cutlery arranged such that at least one item of cutlery is on top of another item of cutlery. As a result, multiple items of cutlery 2106 may be picked up simultaneously by the magnetic end effector 110. Following picking up (or attempting to pick up) the one or more items 2106 of cutlery, an image 2104 may be captured of the surface of the magnetic end effector 110 engaging the cutlery 2106 (“the engagement surface”). Where another type of end effector (e.g., pinch gripper) is used, an image of this type of end effector may likewise be captured from an angle suitable for determining the number of articles grasped. This may be the same camera used to capture an image of the work surface 114 according to the approach of FIGS. 14A and 14B. For example, the processing system 102 may cause the robotic actuator 104 to orient the magnetic end effector to place the engagement surface in the field of view of the same camera.

Alternatively, as shown in FIG. 22, a first camera 2200 or set of cameras 2200 may be used to capture an image of the work surface 114 a second camera 2202 or set of cameras 2202 may be used to capture an image of the engagement surface. The cameras 2200-2202 may be part of the imaging system 106 coupled to the processing system 102.

Referring again to FIG. 21, the image 2104 of the engagement surface may be processed by an object detector 2108 of the processing system 102 that generates bounding boxes 2110 for items of cutlery on the engagement surface. The operation of the object detector 2108 may be the same as the object detector 302 as described above. Where there are multiple items present, this may be determined based on the fact that multiple bounding boxes 2110 are generated.

As an alternative, the image 2104 may be processed by an image classifier 2112 of the processing system 102 that is trained to output a number of objects detected in an image or whether an image includes no objects, a single item of cutlery, or multiple items of cutlery. For example, the image classifier 2112 may be a CNN trained with images that are each annotated with the scenario present in the image (no objects, a single item of cutlery, or multiple items of cutlery) or the number of items present in the image. The result of the image classifier 2112 is therefore an estimate 2114 of the number of objects present.

Referring again to FIG. 22, where multiple items 2106 of cutlery are determined to be engaged with the magnetic end effector using either of the approaches of FIG. 21, the processing system 102 may instruct the robotic actuator 106 to transport the magnetic end effector 110 above a separate work surface 2204 and release the items 2106. Where the end effector is of another type (e.g., pinch gripper) this end effector may be used to grasp and release items in a similar manner. A camera 2206 or set of cameras 2206 of the imaging system 106 may then capture an image of the work surface 2204. This image may then be processed by the object detector 302 and items 2106 may then be grasped individually by the magnetic end effector 110. In particular, releasing the items 2106 may be performed at a height above the surface 2204 that is likely to result in scattering of the items 2106 upon impact, e.g. 15 to 30 centimeters.

The scattered items 2106 of cutlery may then be grasped by the magnetic end effector 110 or by a separate end effector 110 that may be magnetic or non-magnetic, e.g. an actuated gripper or other type of end effector. Note also that the magnetic end effector 110 may be embodied as an actuated gripper (e.g., the pinch gripper discussed above) or other type of end effector that may engage individual items of cutlery or multiple items of cutlery according to the methods described above.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving, by a robotic actuator that includes a magnetic end effector, a command from a processing system to move the magnetic end effector proximate a plurality of articles of cutlery;
engaging, by the robotic actuator, an article of cutlery from the plurality of articles of cutlery using the magnetic end effector;
presenting, by the robotic actuator, the article of cutlery in a field of view of an imaging system;
capturing, by the imaging system, an image of the article of cutlery; and
identifying, by the processing system, a type of the article of cutlery based on the image;

2. The method of claim 1, wherein the type of the article of cutlery includes at least one of:
whether the article of cutlery is a knife, fork, or spoon;
a size of the article of cutlery; and
a brand of the article of cutlery.

3. The method of claim 2, further comprising identifying the type of the article of cutlery using a computer vision algorithm.

4. The method of claim 1, wherein the article of cutlery is one of a plurality of items of cutlery.

5. The method of claim 1, further comprising placing the article of cutlery in a designated location and a designated orientation based on the type of the article of cutlery.

6. The method of claim 5, wherein the plurality of articles of cutlery includes spoons, forks and knives, wherein placing each article of cutlery in a designated location includes identifying and placing all the forks and all the knives at separate designated locations, and wherein remaining articles of cutlery are spoons.

7. The method of claim 1, further comprising aligning, by the robotic actuator, the article of cutlery in a specific orientation when presenting the article of cutlery in a field of view of the imaging system.

8. The method of claim 1, further comprising:
performing image segmentation of a bounding box of the article of cutlery to obtain a mask; and
inputting the mask to a classifier to obtain a polarity of the article of cutlery from the mask.

9. The method of claim 1, further comprising:
determining an oriented bounding box of the article of cutlery from the mask; and
inputting the oriented bounding box and the image of the article of cutlery to a classifier to obtain a polarity of the article of cutlery within the oriented bounding box.

10. The method of claim 9, further comprising:
inputting the oriented bounding box and the image of the item of cutlery to a classifier to obtain an oriented bounding box of the item of cutlery and a location on a handle the item of cutlery within the image of the item of cutlery.

11. The method of claim 1, wherein the article of cutlery is presented in a field of view of the imaging system against a predetermined background.

12. The method of claim 1, wherein the processing system is configured to detect a presence of dirt or damage on the article of cutlery.

13. A method comprising:
receiving, by a robotic actuator, a command from a processing system to engage an article of cutlery, wherein the robotic actuator includes an end effector;
engaging, by the robotic actuator, the article of cutlery using the end effector;
capturing, by an imaging system, an image of the article of cutlery; and
identifying, by the processing system, a type of the article of cutlery based on the image.

14. The method of claim 13, wherein the article of cutlery is presented in a field of view of the imaging system against a predetermined background.

15. The method of claim 13, wherein the article of cutlery is engaged from a collection of a plurality of articles of cutlery.

16. The method of claim 15, further comprising stirring, using the end effector, the collection to facilitate the engagement of the article of cutlery by the robotic actuator.

17. The method of claim 15, further comprising:
processing the image of the article of cutlery by a detector to identify candidates among the plurality of articles of cutlery that are capable of being grasped, manipulated, and moved.

18. The method of claim 15, further comprising
processing the image of the article of cutlery by a detector to identify at least one of articles of cutlery of that are not occluded among the plurality of articles of cutlery and whether no non-occluded articles among the plurality of articles of cutlery.

19. The method of claim 15, further comprising detecting, using at least one of a Hall effect sensor and an inductive sensor coupled to the processing system, whether multiple articles of cutlery have been engaged by the robotic actuator.

20. The method of claim 15, further comprising:
detecting, using at least one of an image classifier and an image detector coupled to the processing system, whether multiple articles of cutlery are engaged by the end effector.

21. The method of claim 20, further comprising:
determining that multiple articles of cutlery are engaged by the end effector;
in response to determining that multiple articles of cutlery are engaged by the end effector, dropping, by the end effector, the multiple articles of cutlery on an unoccupied surface effective to disperse the multiple articles of cutlery on the unoccupied surface.

22. The method of claim 21, further comprising:
picking up the multiple articles of cutlery one at a time from the unoccupied surface using a second end effector.

23. The method of claim 13, further comprising detecting, by the processing system, presence of dirt or damage on the article of cutlery.

24. The method of claim 13, wherein the article of cutlery is engaged by the robotic actuator prior to being identified by the processing system.

25. The method of claim 13, wherein the imaging system captures the image responsive to the article of cutlery being presented by the robotic actuator in a field of view of the imaging system.

26. The method of claim 13, further comprising placing, by the processing system and the robotic actuator, the article of cutlery in a designated location based on the type of the article of cutlery.

27. An apparatus comprising:
a robotic actuator that includes an end effector;
a processing system configured to command the robotic actuator to move the end effector proximate to a plurality of articles of cutlery and engage an article of cutlery using the end effector; and
an imaging system configured to capture an image of the article of cutlery responsive to the article of cutlery being presented in a field of view of the imaging system by the robotic actuator, wherein the processing system is configured to identify the article of cutlery based on the image.

28. The apparatus of claim 27, wherein the robotic actuator is an X-Y gantry robot.

29. The apparatus of claim 27, wherein the end effector includes a cube magnet that is configured such that an article of cutlery engaged by the end effector is aligned in a predetermined direction by the cube magnet.

30. The apparatus of claim 27, wherein the processing system and the robotic actuator are programmed to place the article of cutlery in a designated location based on identification of the article of cutlery.

31. The apparatus of claim 27, wherein the processing system and the robotic actuator are programmed to rotate the article of cutlery into a specified spatial orientation by a magnet, prior to being engaged by the end effector.

32. The apparatus of claim 27, wherein the processing system is further programmed to determine an oriented bounding box of the article of cutlery and cause the robotic actuator to engage the article of cutlery according to a position and orientation of the oriented bounding box.
